(19) United States
(12) Patent Application Publication
(10) Pub. No.: US 2024/0305012 A1
(43) Pub. Date: Sep. 12, 2024

(54) REDUCED LENGTH SUSPENDED STRIPLINE TO DOUBLE RIDGE WAVEGUIDE TRANSITION

(71) Applicant: Lisa Dräxlmaier GmbH, Vilsbiburg (DE)

(72) Inventor: Paul KLASMANN, Ebhausen (DE)

(73) Assignee: Lisa Dräxlmaier GmbH, Vilsbiburg (DE)

(21) Appl. No.: 18/597,516

(22) Filed: Mar. 6, 2024

(30) Foreign Application Priority Data
Mar. 8, 2023 (GB) 2303382.2

(51) Int. Cl. H01Q 21/00; H01Q 1/28; H01Q 1/48

(52) U.S. Cl. CPC H01Q 21/0075; H01Q 1/28; H01Q 1/48

(57) ABSTRACT

An apparatus that includes a dielectric substrate having a top side and a bottom side opposing the top side and a stripline placed at the top side of the substrate. The stripline includes a waveguide feeding terminal feed the apparatus with an electrical signal and at least one waveguide transition terminal to transition the electrical signal into a radio frequency signal via a waveguide. The apparatus further includes at least one metal patch placed at the bottom side of the substrate below at least one of the waveguide feeding terminal and the at least one waveguide transition terminal. The at least one metal patch is to shape a coupling of the electrical signal with the radio frequency signal in order to match the stripline to the waveguide.

### CROSS-REFERENCE TO RELATED APPLICATIONS

This application claims priority to and the benefit of British Application No. 2 303 382.2 filed on Mar. 8, 2023. The disclosure of the above application is incorporated herein by reference.

### FIELD

The present disclosure relates to a reduced length suspended stripline to double ridge waveguide transition that can be used in an array antenna for aircraft tail-mount applications, in particular in the Ka-band for satellite-based communications.

### BACKGROUND

The statements in this section merely provide background information related to the present disclosure and may not constitute prior art.

Currently available Ka-band array antennas for aircraft tail-mount applications use many Suspended-Stripline (SSL) to double ridge waveguide transitions within the internal feeding network. Multiple steps in the waveguide cross section are desired to produce a good match from the SSL transmission line to the waveguide. By these stepped waveguide design, the reflections in this component can be kept low and more RF (radio frequency) energy can be transmitted via this component. Hence, known antenna designs use multiple steps in the waveguide cross section to control the fields in such a way as to provide a good broadband or multiband match. The main disadvantage of such a stepped waveguide design is that multiple steps of the waveguide cross section add to the depth and also the mass of the antenna aperture. The steps in the waveguide add several millimeters to the depth of the antenna aperture which increases the total size of the antenna and finally, the antenna is not able to fit within the restricted volume of the customer's tail-mount radome. When removing these steps, several millimetres can be deducted from the aperture depth, but the performance of the transition may be severely degraded.

An additional disadvantage of the stepped waveguide is the possibility of very small gaps between the waveguide ridges. This can be a manufacturing issue if the gap is too small. Care has to be taken to provide that a reasonable cutting tool can fit between the small gap between the waveguide ridges.

### SUMMARY

This section provides a general summary of the disclosure and is not a comprehensive disclosure of its full scope or all of its features.

The present disclosure provides a compact apparatus for transition between an electrical signal and a radio frequency signal without steps in the waveguide cross section that fits in the restricted volume of the tail-mount radome as specified by the customer without severely degrading its performance.

The method that was found to restore RF (radio frequency) performance to the shorter transition was to introduce a small rectangular patch of copper on the opposite side of the SSL RF PCB (Printed Circuit Board). This was used for each of the many transitions throughout the aperture. With these patches the steps may be omitted and the waveguide cross section is unmodified and more simple to produce.

The present disclosure is based on the finding that a similar effect as produced by the steps in the waveguide cross section can be obtained by introducing a small rectangular patch of copper on the opposite side of the signal conductor of the SSL PCB. This means that additional components may be omitted and that the patch can be etched as part of the PCB manufacture that is performed regardless to etch the ground plane geometry of the PCB.

The patch of copper works by modifying the match of the inductive finger of the SSL in the waveguide region, adding capacitance in the transition region in such a way as to provide a good match and therefore maximum power transfer at the desired receiving and transmitting bands. It is the complex combination of the inductive “finger” and capacitive patch that improves the match between the SSL and waveguide transition region. The precise position and size of each patch may be predetermined.

The advantage of the present disclosure over the current state of the art is that it allows the antenna to fit within the specified radome as desired by the customer. The antenna introduced hereinafter is better performing than a traditional reflector antenna. The disclosed apparatus operates over a broader bandwidth in both receiving and transmitting bands compared to conventional antennas and offers greater aperture efficiency for the same diameter when compared to a traditional reflector antenna.

Further advantages are that there is no extra cost in the manufacture of the RF PCB, a less complicated machining in Aluminium waveguide parts, reduced antenna aperture depth and reduced antenna aperture mass because it will be thinner. The reason to make the aperture thinner is because the aperture is attached to a positioner which must also fit into the small volume allowed in the aircraft's tail radome. A reduction in height of about 0.265) at 30 GHz was obtained for the single SSL to waveguide. The double SSL to waveguide transition has a reduction in height of about 0.388\ at 30 GHz.

A waveguide as described in this disclosure is a structure that guides waves, such as electromagnetic waves, with a reduced loss of energy by restricting the transmission of energy to one direction.

A ridged waveguide as described in this disclosure is a waveguide with conducting ridges protruding into the center of the waveguide from the top wall or bottom wall or both walls. The ridges are parallel to the short wall of the waveguide. A rectangular waveguide with a single protruding ridge from the top or bottom wall is called a Single Ridged Waveguide. A rectangular waveguide with a ridge from the top and bottom wall is called a Double Ridged Waveguide. Ridged Waveguides have a lower impedance and wider bandwidth in their fundamental mode when compared to regular rectangular waveguides. They also have a lower cut-off frequency and have lower power handling capabilities. Ridged waveguides can be used for impedance matching as they decrease the characteristic impedance of the waveguide. Besides, they offer higher bandwidth in comparison to the conventional waveguides.

A stripline or stripline circuit as described in this disclosure uses a flat strip of metal which is sandwiched between two parallel ground planes. The insulating material of the substrate forms a dielectric. The width of the strip, the thickness of the substrate and the relative permittivity of the substrate determine the characteristic impedance of the strip which is a transmission line. The central conductor may not be equally spaced between the ground planes. In the general case, the dielectric material may be different above and below the central conductor. To inhibit the propagation of unwanted modes, the two ground planes should be shorted together. This can be achieved by a series of vias that may run parallel to the strip on each side.

A suspended stripline (SSL) as described in this disclosure is etched out on a thin substrate and the entire structure is enclosed. Thus, the stripline is suspended in the metallic structure. The suspended stripline has air as dielectric on both sides. The suspended stripline configuration supports pure TEM mode propagation. The SSL has the following advantages: No spurious radiation; wider bandwidth of operation; low losses; and high Q factor.

A metal patch is described in this disclosure. The metal patch is a planar sheet of metal or metal foil of various shapes on the surface of a substrate, e.g., a printed circuit board (PCB). The metal patch can be rectangular shaped and can be made of Copper, for example.

In this disclosure communication in the Ka-band is described. Specifically, the frequency range of the Ka-band, as defined by the IEEE system, is from 26 to 40 GHz, with a wavelength of 11.5 mm at 26 GHz and 7.5 mm at 40 GHz in free space. The Ka-band spectrum is widely used for broadband data communications, mobile phone and data applications, and direct-to-home (DTH) broadcasting. Ka-band transceivers, transmitters, and receivers provide high data throughput and bandwidth due to their operation in this Ka-band part of the frequency spectrum. Most High Throughput Satellites (HTS) operating in the Ka-band typically fall within the following Ka-bands: 27.5-31 GHz (uplink) and 17.7-21.2 GHZ (downlink), for a 3.5 GHz bandwidth.

According to a first aspect, the disclosure relates to an apparatus for transition between an electrical signal and a radio frequency signal, comprising: a dielectric substrate having a top side and a bottom side opposing the top side; a stripline placed at the top side of the substrate, the stripline comprising a waveguide feeding terminal for feeding the apparatus with an electrical signal and at least one waveguide transition terminal for transition of the electrical signal into a radio frequency signal via a waveguide; and at least one metal patch placed at the bottom side of the substrate below at least one of the waveguide feeding terminal and the at least one waveguide transition terminal; wherein the at least one metal patch is configured to shape a coupling of the electrical signal with the radio frequency signal in order to match the stripline to the waveguide.

Such apparatus can be compact due to the missing steps in the waveguide cross section such that the apparatus fits in the restricted volume of the tail-mount radome as specified by the customer without severely degrading its performance.

By introducing the metal patches on the opposite side of the substrate steps may be omitted and the waveguide cross section can be unmodified and more simple to produce. The metal patches can produce a similar effect than the steps in the waveguide cross section. Hence, additional components may be omitted and both, size and weight of the waveguide can be reduced without degrading the performance.

In an exemplary implementation of the apparatus, the apparatus comprises a waveguide attached to the substrate, wherein the waveguide is a stepless waveguide having a constant cross-section.

This provides the advantage that a stepless waveguide with constant cross-section can have a reduced length compared to a stepped waveguide, thereby fitting in the restricted space of the tail-mount radome. By the introduced metal patches, the performance of the apparatus is not decreased.

In an exemplary implementation of the apparatus, the waveguide feeding terminal and the at least one waveguide transition terminal are formed as inductive fingers; wherein the at least one metal patch forms a capacitive component interacting with a respective inductive finger to form an impedance of the waveguide feeding terminal and the at least one waveguide transition terminal.

This provides the advantage that the inductive component of the fingers and the capacitive component of the metal patches can be adjusted by design in order to obtain a match of the stripline to the waveguide resulting in an improved antenna gain.

An inductive finger describes a protruding section of the stripline that provides an inductive component. The inductive finger may be formed as a hook, for example. At the inductive finger, a course of the line may vary between different directions in order to implement the inductive component.

In an exemplary implementation of the apparatus, the inductive fingers of at least two waveguide transition terminals are aligned to point into the same direction.

This provides the advantage that a phase of each waveguide transition terminal can be equal. Thus, an improved antenna array can be designed with multiple such apparatuses.

In an exemplary implementation of the apparatus, the at least one metal patch is rectangular shaped.

This provides the advantage that the metal patch can be easily manufactured, e.g., by cutting a metal foil into smaller parts.

In an exemplary implementation of the apparatus, the stripline comprises a suspended-stripline; and/or the waveguide comprises a double-ridge waveguide.

Such suspended-stripline provides the advantages of no spurious radiation, wider bandwidth of operation, low losses and high Q factor. The double-ridge waveguide provides the advantage of a low impedance and wide bandwidth in its fundamental mode when compared to a regular rectangular waveguide. The double-ridge waveguide also has a lower cut-off frequency and lower power handling capabilities. The double-ridge waveguide can be efficiently used for impedance matching as it decreases the characteristic impedance of the waveguide. Besides, the double-ridge waveguide offers higher bandwidth in comparison to a regular rectangular waveguide.

In an exemplary implementation of the apparatus, the substrate is a printed circuit board comprising a top side metallization and a bottom side metallization; and the stripline is formed as an etched signal trace within the top side metallization and the at least one metal patch is formed as an etched metal island within the bottom side metallization.

This provides the advantage that the apparatus can be easily manufactured when using a printed circuit board. The manufacturing steps for producing the stripline and the metal patches can be efficiently performed by a production machine.

In an exemplary implementation of the apparatus, the apparatus comprises: an upper ground plane arranged above the top side of the substrate outside an outline of the etched signal trace; a lower ground plane arranged below the bottom side of the substrate outside an outline of the etched metal island; and a series of vias electrically connecting the upper ground plane with the lower ground plane.

This provides the advantage that a suspended stripline can be easily manufactured. This suspended stripline configuration supports pure TEM mode propagation and provides the advantages of no spurious radiation, wider bandwidth of operation, low losses and high Q factor.

In an exemplary implementation of the apparatus, the at least one waveguide transition terminal comprises: two waveguide transition terminals forming the apparatus as a 1-to-2 combiner-divider device; four waveguide transition terminals forming the apparatus as a 1-to-4 combiner-divider device; or a single waveguide transition terminal forming the apparatus as a 1-to-1 coupling device.

This provides the advantage that apparatus can be flexibly designed according to the desires of the customer, e.g., as one of the above configurations, including a 1-to-2 combiner-divider device, a 1-to-4 combiner-divider device or a 1-to-1 coupling device. Higher stage combiner-divider devices can be implemented by using multiple such devices.

In an exemplary implementation of the apparatus, the stripline comprises stepped sections, the stepped sections shaping an impedance of the waveguide feeding terminal and the at least one waveguide transition terminal.

This provides the advantage that the impedance can be shaped for an improved match of the stripline to the waveguide, hence improving the antenna gain.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A shows a bottom view of a schematic diagram illustrating the bottom side of a substrate of an apparatus according to the present disclosure forming a 1×2 combiner/divider device;

FIG. 1B shows a top view of a schematic diagram illustrating the top side of the substrate of the apparatus according to the present disclosure;

FIG. 1C shows a top view of a schematic diagram illustrating the location of the metal patches in relation to the stripline without the substrate in between according to the present disclosure;

FIG. 1D shows a perspective view of a 1×2 SSL to double ridged waveguide RF PCB of the apparatus according to the present disclosure;

FIG. 2 shows a perspective view of a 1×2 SSL to double ridged waveguide according to one form of the present disclosure;

FIG. 3 shows an exemplary frequency response of the 1×2 SSL to double ridged waveguide according to the present disclosure;

FIG. 4A shows a bottom view of a schematic diagram illustrating the bottom side of a substrate of an apparatus according to the present disclosure forming a 1×4 combiner/divider device;

FIG. 4B shows a top view of a schematic diagram illustrating the top side of the substrate of the apparatus according to the present disclosure;

FIG. 4C shows a top view of a schematic diagram illustrating the location of the metal patches in relation to the stripline without the substrate in between according to the present disclosure;

FIG. 4D shows a perspective view of a 1×4 SSL to double ridged waveguide RF PCB of the apparatus according to the present disclosure;

FIG. 5 shows a perspective view of a 1×4 SSL to double ridged waveguide according to one form of the present disclosure;

FIG. 6 shows an exemplary frequency response of the 1×4 SSL to double ridged waveguide according to the present disclosure;

FIG. 7A shows a schematic diagram illustrating waveguide depth reduction over a waveguide having a one-step waveguide cross section according to the present disclosure;

FIG. 7B shows a schematic diagram illustrating waveguide depth reduction over a waveguide having a two-step waveguide cross section according to the present disclosure;

FIG. 8A shows a bottom view of a schematic diagram illustrating the bottom side of a substrate of an apparatus according to the present disclosure forming a 1×1 coupling device; and

FIG. 8B shows a top view of a schematic diagram illustrating the top side of the substrate of the apparatus according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

It is understood that comments made in connection with a described method may also hold true for a corresponding device or system configured to perform the method and vice versa. Further, it is understood that the features of the various exemplary aspects described herein may be combined with each other, unless specifically noted otherwise.

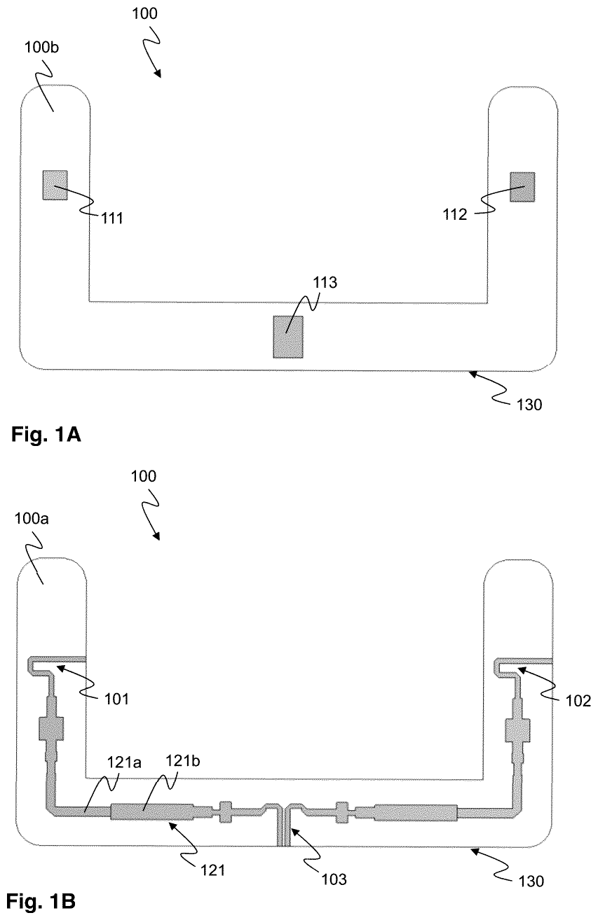

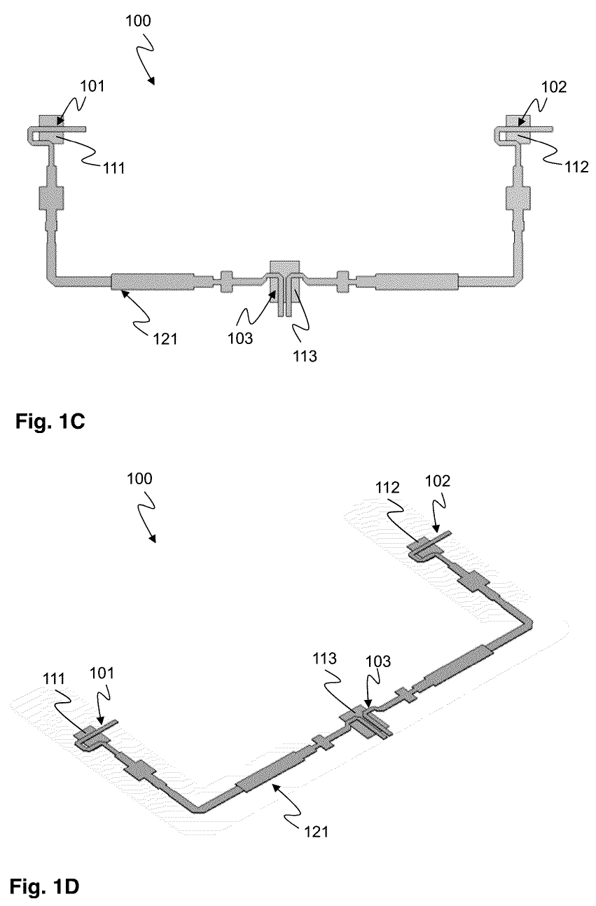

FIG. 1A shows a schematic diagram illustrating a bottom side 100b of a substrate 100 of an apparatus 200 according to the disclosure forming a 1×2 combiner/divider device.

The substrate 100 is a dielectric substrate 100 having a top side 100a, shown in FIG. 1B, and a bottom side 100b opposing the top side 100a. In FIG. 1A, the bottom side 100b of the substrate 100 is shown. An exemplary number of three metal patches 111, 112, 113 are placed at the bottom side 100b of the substrate 100. These metal patches 111, 112, 113 are placed below a waveguide feeding terminal 103 and two waveguide transition terminals 101, 102 of a stripline 121 placed on the top side 100a of the substrate 100 as shown in FIG. 1B.

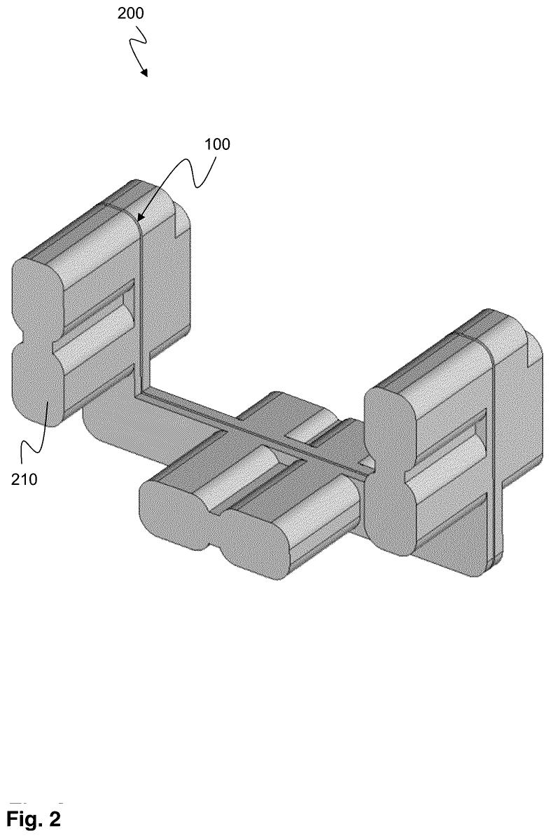

The metal patches 111, 112, 113 are configured to shape a coupling of the electrical signal with the radio frequency signal in order to match the stripline 121 to the waveguide 210 which is shown in FIG. 2.

The metal patches 111, 112, 113 may be rectangular shaped as shown in FIG. 1A. The metal patches 111, 112, 113, may be made of Copper, for example.

The substrate 100 may be a printed circuit board (PCB) comprising a top side metallization and a bottom side metallization. The stripline 121 as shown in FIG. 1B may be formed as an etched signal trace within the top side metallization. The metal patches 111, 112, 113 may be formed as etched metal islands within the bottom side metallization.

An upper ground plane (not shown in FIG. 1B) may be arranged above the top side 100a of the substrate 100 outside an outline 130 of the etched signal trace. A lower ground plane (not shown in FIG. 1A) may be arranged below the bottom side 100b of the substrate 100 outside an outline 130 of the etched metal island. A series of vias (not shown in FIGS. 1A and 1B) may electrically connect the upper ground plane with the lower ground plane.

FIG. 1B shows a schematic diagram illustrating the top side 100a of the substrate 100 of the apparatus 200.

As described above, the substrate 100 is a dielectric substrate 100 having a top side 100a and a bottom side 100b opposing the top side 100a. In FIG. 1B, the top side 100a of the substrate 100 is shown. A stripline 121 is placed at the top side 100a of the substrate 100. The stripline 121 comprises a waveguide feeding terminal 103 for feeding the apparatus 200 with an electrical signal and an exemplary number of two waveguide transition terminals 101, 102 for transition of the electrical signal into a radio frequency signal via a waveguide 210 (shown in FIG. 2).

The metal patches 111, 112, 113 shown in FIG. 1A are placed at the bottom side 100b of the substrate 100 below the waveguide feeding terminal 103 and the two waveguide transition terminals 101, 102.

The metal patches 111, 112, 113 are configured to shape a coupling of the electrical signal with the radio frequency signal in order to match the stripline 121 to the waveguide 210 (shown in FIG. 2).

A waveguide 210 (shown in FIG. 2) can be attached to the substrate 100 as shown in FIG. 2. The waveguide 210 may be a stepless waveguide having a constant cross-section.

As shown in FIG. 1B, the waveguide feeding terminal 103 and the two waveguide transition terminals 101, 102 may be formed as inductive fingers, e.g., like a hook as can be seen from FIG. 1B. The metal patches 111, 112, 113 on the bottom side 100b of the substrate 100 as shown in FIG. 1A may form a capacitive component interacting with a respective inductive finger of the stripline 121 to form an impedance of the waveguide feeding terminal 103 and the two waveguide transition terminals 101, 102.

As shown in FIG. 1B, the inductive fingers of the two waveguide transition terminals 101, 102 are aligned to point into the same direction, e.g., on the right side of the picture as shown in FIG. 1B.

The stripline 121 may be or may comprise a suspended-stripline (SSL). The waveguide 210 may be or may comprise a double-ridge waveguide as shown in FIG. 2, for example.

The substrate 100 can be a printed circuit board comprising a top side metallization and a bottom side metallization. The stripline 121 may be formed as an etched signal trace within the top side metallization and the metal patches 111, 112, 113 (shown in FIG. 1A) may be formed as etched metal islands within the bottom side metallization.

In the example shown in FIGS. 1A to 1D and 2, the waveguide transition terminals 101, 102 are two waveguide transition terminals 101, 102 which form the apparatus as a 1-to-2 combiner-divider device 200 (see FIG. 2).

As can be seen in FIG. 1B, the stripline 121 comprises a plurality of stepped sections 121a, 121b which are designed for shaping an impedance of the waveguide feeding terminal 103 and the two waveguide transition terminals 101, 102. The stepped sections 121a, 121b are designed for a matching of the stripline 121 with the waveguide 210. Note that only two of these stepped sections 121a, 121b are referred to by reference signs 121a, 121b. The other stepped sections without reference signs are also contributing to the design of the stripline 121 characteristics.

FIG. 1C shows a schematic diagram illustrating the location of the metal patches 111, 112, 113 in relation to the stripline 121 without the substrate 100 in between.

As can be seen from FIG. 1C, the metal patches 111, 112, 113 are placed at the bottom side 100b of the substrate 100 below the waveguide feeding terminal 103 and the two waveguide transition terminals 101, 102. That means, the first metal patch 111 is placed below the first waveguide transition terminal 101, the second metal patch 112 is placed below the second waveguide transition terminal 102 and the third metal patch 113 is placed below the waveguide feeding terminal 103.

A size of the metal patches 111, 112, 113 is improved with respect to a desired match of the stripline 121 to the waveguide 210 (shown in FIG. 2).

In this example of FIG. 1C, the metal patches 111, 112, 113 fit below the hooked section of the respective terminals 101, 102, 103.

The stripline 121 shown in FIG. 1C has two parts, one part extending from the waveguide feeding terminal 103 to the first waveguide transition terminal 101 and a second part extending from the waveguide feeding terminal 103 to the second waveguide transition terminal 102. Both parts of the stripline 121 are symmetrical in order to implement a symmetrically operating 1×2 combiner/divider device.

FIG. 1D shows a perspective view of a 1×2 SSL to double ridged waveguide RF PCB of the apparatus 200.

As described above, the dielectric substrate 100 has a top side 100a, shown in FIG. 1B, and a bottom side 100b, shown in FIG. 1A. The stripline 121 is placed at the top side 100a of the substrate 100 and the metal patches 111, 112, 113 are placed at the bottom side 100b of the substrate 100 or vice versa.

The stripline 121 comprises a waveguide feeding terminal 103 for feeding the apparatus 200 (shown in FIG. 2) with an electrical signal and at least one waveguide transition terminal 101, 102 for transition of the electrical signal into a radio frequency signal via a waveguide 210.

The metal patches 111, 112, 113 are placed at the bottom side 100b of the substrate 100 below the waveguide feeding terminal 103 and the waveguide transition terminals 101, 102.

The metal patches 111, 112, 113 are configured to shape a coupling of the electrical signal with the radio frequency signal in order to match the stripline 121 to the waveguide 210.

FIG. 2 shows a perspective view of a 1×2 SSL to double ridged waveguide 200 according to one form.

The apparatus 200, which is here a 1×2 SSL to double ridged waveguide 200, comprises a dielectric substrate 100 as described above with respect to FIGS. 1A to 1D and a waveguide 210 attached to the substrate 100. The waveguide 210 is a stepless waveguide having a constant cross section.

The waveguide 210 encloses the substrate 100 from both sides 100a and 100b of the substrate 100 to form a sandwich-like structure.

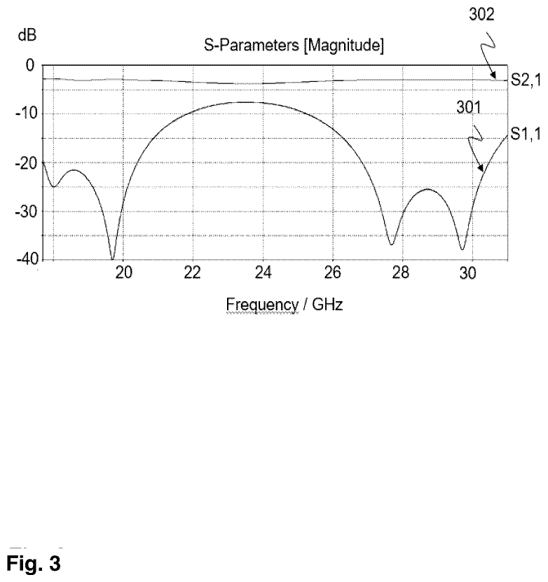

FIG. 3 shows an exemplary frequency response of the 1×2 SSL to double ridged waveguide 200.

FIG. 3 shows the typical frequency response of the 1×2 divider with uniform waveguide as a result of introducing the capacitive patches 111, 112, 113 as described above with respect to FIGS. 1A to 1D and 2 to improve the match of the divider.

The first S-parameter S1,1 is denoted by reference sign 301 and the second S-parameter S2,1 is denoted by reference sign 302.

The first S-parameter S1,1 is below-20 dB between 17.7 GHZ and 20.2 GHz, and 27.5 GHz and 30 GHz.

The second S-parameter S2, 1 is at about-3 dB over the whole shown frequency range between 17.7 GHZ and 31 GHz.

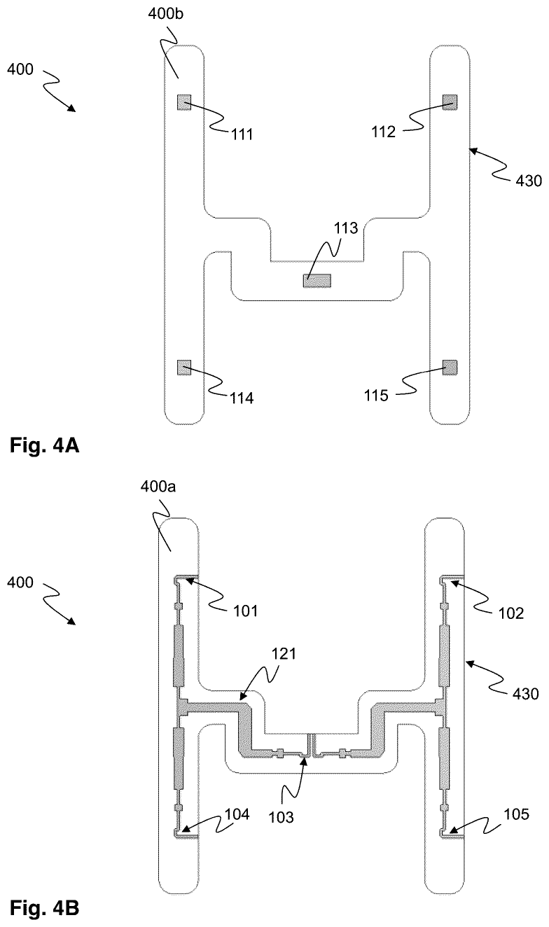

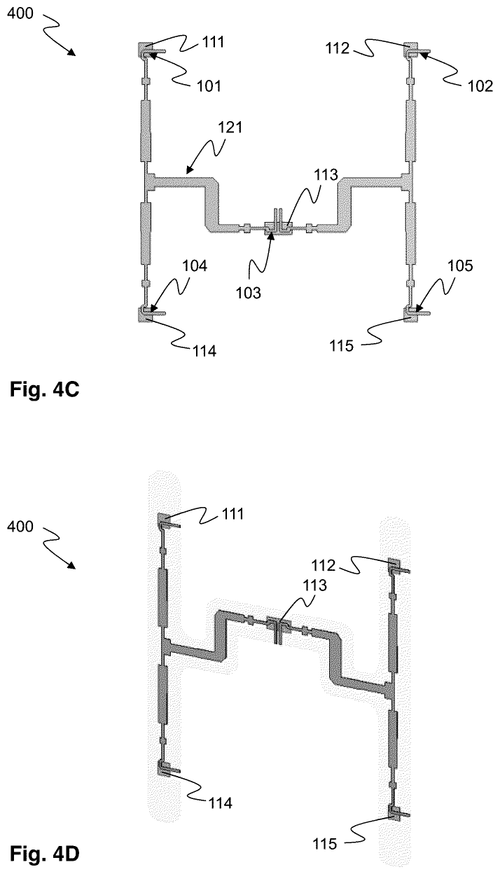

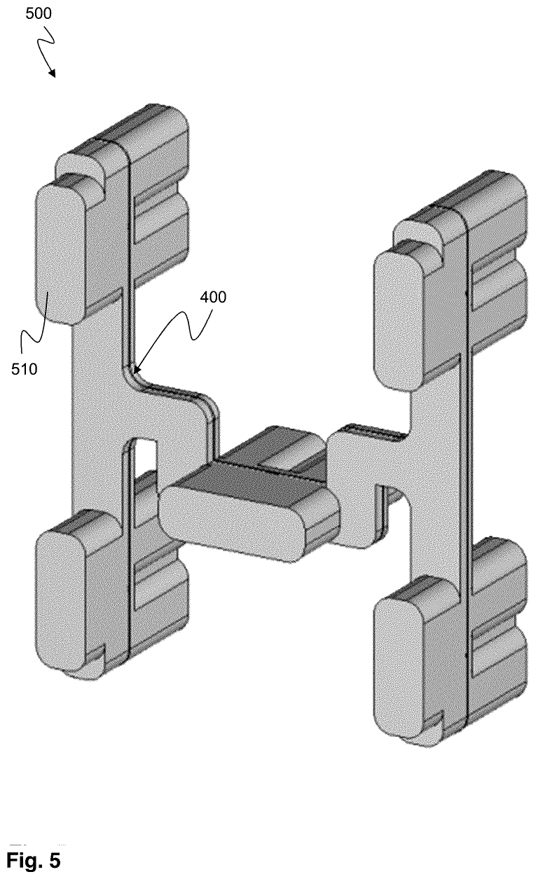

FIG. 4A shows a schematic diagram illustrating the bottom side 400b of a substrate 400 of an apparatus 500 (shown in FIG. 5) according to the disclosure forming a 1×4 combiner/divider device.

Similar to the description of FIGS. 1A to 1D, the substrate 400 is a dielectric substrate 400 having a top side 400a and a bottom side 400b opposing the top side 400a. In FIG. 4A, the bottom side 400b of the substrate 400 is shown. An exemplary number of five metal patches 111, 112, 113, 114, 115 are placed at the bottom side 400b of the substrate 400. These metal patches 111, 112, 113, 114, 115 are placed below a waveguide feeding terminal 103 and four waveguide transition terminals 101, 102, 104, 105 of a stripline 121 placed on the top side 400a of the substrate 400 as shown in FIG. 4B.

The metal patches 111, 112, 113, 114, 115 are configured to shape a coupling of the electrical signal with the radio frequency signal in order to match the stripline 121 to the waveguide 510 which is shown in FIG. 5.

The metal patches 111, 112, 113, 114, 115 may be rectangular shaped as shown in FIG. 4A. The metal patches 111, 112, 113, 114, 115 may be made of Copper, for example.

The substrate 400 may be a printed circuit board (PCB) comprising a top side metallization and a bottom side metallization. The stripline 121 as shown in FIG. 4B may be formed as an etched signal trace within the top side metallization. The metal patches 111, 112, 113, 114, 115 may be formed as etched metal islands within the bottom side metallization.

An upper ground plane (not shown in FIG. 4B) may be arranged above the top side 400a of the substrate 400 outside an outline 430 of the etched signal trace. A lower ground plane (not shown in FIG. 4A) may be arranged below the bottom side 400b of the substrate 400 outside an outline 430 of the etched metal island. A series of vias (not shown in FIGS. 4A and 4B) may electrically connect the upper ground plane with the lower ground plane.

FIG. 4B shows a schematic diagram illustrating the top side 400a of the substrate 400 of the apparatus 500.

As described above, the substrate 400 is a dielectric substrate 400 having a top side 400a and a bottom side 400b opposing the top side 400a. In FIG. 4B, the top side 400a of the substrate 400 is shown. A stripline 121 is placed at the top side 400a of the substrate 400. The stripline 121 comprises a waveguide feeding terminal 103 for feeding the apparatus 200 with an electrical signal and an exemplary number of four waveguide transition terminals 101, 102, 104, 105 for transition of the electrical signal into a radio frequency signal via a waveguide 510 (shown in FIG. 5).

The metal patches 111, 112, 113, 114, 115 shown in FIG. 4A are placed at the bottom side 400b of the substrate 400 below the waveguide feeding terminal 103 and the four waveguide transition terminals 101, 102, 104, 105.

The metal patches 111, 112, 113, 114, 115 are configured to shape a coupling of the electrical signal with the radio frequency signal in order to match the stripline 121 to the waveguide 510 (shown in FIG. 5).

The waveguide 510 (shown in FIG. 5) can be attached to the substrate 400 as shown in FIG. 5. The waveguide 510 may be a stepless waveguide having a constant cross-section.

As shown in FIG. 4B, the waveguide feeding terminal 103 and the four waveguide transition terminals 101, 102, 104, 105 may be formed as inductive fingers, e.g. like a hook as can be seen from FIG. 4B. The metal patches 111, 112, 113, 114, 115 on the bottom side 400b of the substrate 400 as shown in FIG. 4A may form a capacitive component interacting with a respective inductive finger of the stripline 121 to form an impedance of the waveguide feeding terminal 103 and the four waveguide transition terminals 101, 102, 104, 105.

As shown in FIG. 4B, the inductive fingers of the four waveguide transition terminals 101, 102, 104, 105 are aligned to point into the same direction, e.g., on the right side of the picture as shown in FIG. 4B.

FIG. 4C shows a schematic diagram illustrating the location of the metal patches 111, 112, 113, 114, 115 in relation to the stripline 121 without the substrate 400 in between.

As can be seen from FIG. 4C, the metal patches 111, 112, 113, 114, 115 are placed at the bottom side 400b of the substrate 400 below the waveguide feeding terminal 103 and the four waveguide transition terminals 101, 102, 104, 105. That means, the first metal patch 111 is placed below the first waveguide transition terminal 101, the second metal patch 112 is placed below the second waveguide transition terminal 102, the third metal patch 113 is placed below the waveguide feeding terminal 103, the fourth metal patch 114 is placed below the third waveguide transition terminal 104 and the fifth metal patch 115 is placed below the fourth waveguide transition terminal 105.

A size of the metal patches 111, 112, 113, 114, 115 is improved with respect to a desired match of the stripline 121 to the waveguide 510 (shown in FIG. 5).

In this example of FIG. 4C, the metal patches 111, 112, 113, 114, 115 fit below the hooked section of the respective terminals 101, 102, 103, 104, 105.

The stripline 121 shown in FIG. 4C has two parts, each part having two branches. The first part is extending from the waveguide feeding terminal 103 to the first waveguide transition terminal 101 and the third waveguide transition terminal 104, wherein a first branch is branching to the first waveguide transition terminal 101 and a second branch is branching to the third waveguide transition terminal 104. The second part is extending from the waveguide feeding terminal 103 to the second waveguide transition terminal 102 and the fourth waveguide transition terminal 105, wherein a first branch is branching to the second waveguide transition terminal 102 and a second branch is branching to the fourth waveguide transition terminal 105.

Both parts of the stripline 121 are symmetrically formed and each branch of a respective part is symmetrically formed in order to implement a symmetrically operating 1×4 combiner/divider device.

FIG. 4D shows a perspective view of a 1×4 SSL to double ridged waveguide RF PCB 400 of the apparatus 500.

As described above, the dielectric substrate 400 has a top side 400a, shown in FIG. 4B, and a bottom side 400b, shown in FIG. 4A. The stripline 121 is placed at the top side 400a of the substrate 400 and the metal patches 111, 112, 113, 114, 115 are placed at the bottom side 400b of the substrate 400 or vice versa.

The stripline 121 comprises a waveguide feeding terminal 103 for feeding the apparatus 500 (shown in FIG. 5) with an electrical signal and at least one waveguide transition terminal 101, 102, 104, 105 for transition of the electrical signal into a radio frequency signal via a waveguide 510.

The metal patches 111, 112, 113, 114, 115 are placed at the bottom side 400b of the substrate 400 below the waveguide feeding terminal 103 and the waveguide transition terminals 101, 102, 104, 105.

The metal patches 111, 112, 113, 114, 115 are configured to shape a coupling of the electrical signal with the radio frequency signal in order to match the stripline 121 to the waveguide 510.

FIG. 5 shows a perspective view of a 1×4 SSL to double ridged waveguide 500 according to one form.

The apparatus 500, which is here a 1×4 SSL to double ridged waveguide 500, comprises a dielectric substrate 400 as described above with respect to FIGS. 4A to 4D and a waveguide 510 attached to the substrate 400. The waveguide 510 is a stepless waveguide having a constant cross section.

The waveguide 510 encloses the substrate 400 from both sides 400a and 400b of the substrate 400 to form a sandwich-like structure.

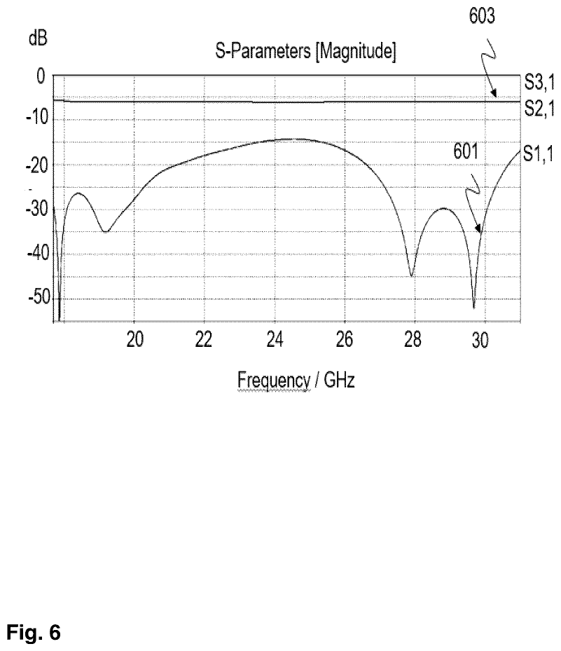

FIG. 6 shows an exemplary frequency response of the 1×4 SSL to double ridged waveguide 500.

FIG. 6 shows the typical frequency response of the 1×4 divider with uniform waveguide as a result of introducing the capacitive patches 111, 112, 113, 114, 115 as described above with respect to FIGS. 4A to 4D and 5 to improve the match of the divider.

The first S-parameter S1,1 is denoted by reference sign 601. The third S-parameter S3,1 and the second S-parameter S2,1 are denoted by reference sign 603.

The first S-parameter S1,1 is below-25 dB between 17.7 GHz to 20.2 GHz and less than-30 dB between 27.5 GHz to 30 GHz.

The third S-parameter S3,1 and the second S-parameter S2, 1 are at about-6 dB over the whole shown frequency range between 17.7 GHZ and 31 GHz.

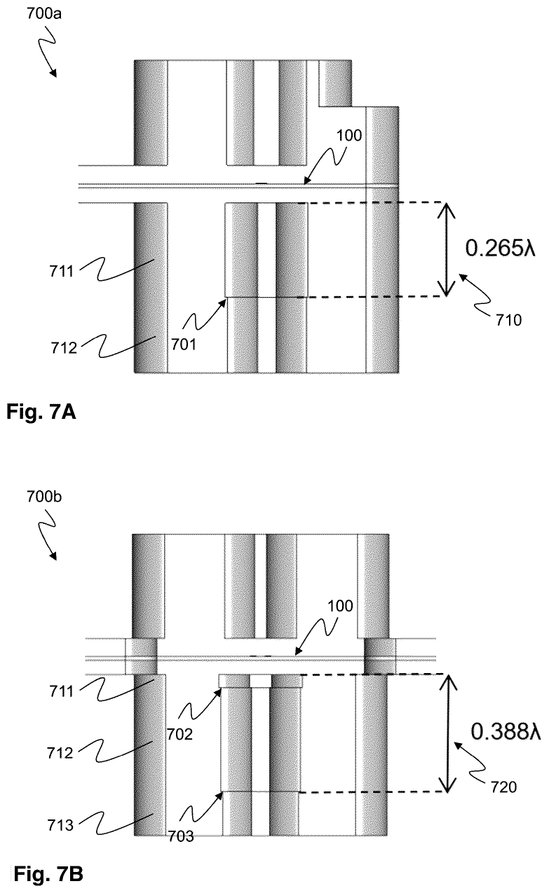

FIG. 7A shows a schematic diagram illustrating waveguide depth reduction over a waveguide 700a having a one-step waveguide cross section.

By applying the metal patches 111, 112, 113 as introduced in this disclosure, the step profile 711, 712 of the waveguide 700a with one step 701 between both waveguide sections 711, 712 as shown in FIG. 7A can be reduced to a step-less waveguide resulting in a length reduction of about 0.265λ.

FIG. 7B shows a schematic diagram illustrating waveguide depth reduction over a waveguide having a two-step waveguide cross section.

By applying the metal patches 111, 112, 113 as introduced in this disclosure, the step profile 711, 712, 713 of the waveguide 700b with two steps 702, 703 between the three waveguide sections 711, 712, 713 as shown in FIG. 7B can be reduced to a step-less waveguide resulting in a length reduction of about 0.388λ.

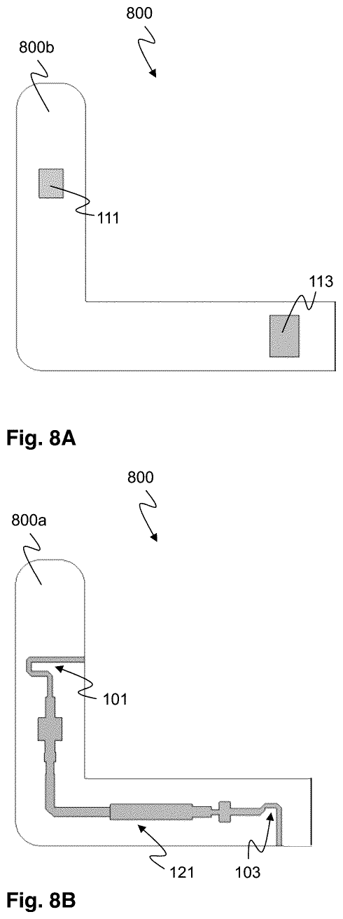

FIG. 8A shows a schematic diagram illustrating the bottom side 100b of a substrate 800 of an apparatus according to the disclosure forming a 1×1 device.

The substrate 800 may correspond to one half of the substrate 100 described above with respect to FIGS. 1A to 1D, which is cut into two halves.

The substrate 800 is a dielectric substrate 800 having a top side 800a and a bottom side 800b opposing the top side 800a, shown in FIG. 8B. In FIG. 8A, the bottom side 800b of the substrate 800 is shown. An exemplary number of two metal patches 111, 113 are placed at the bottom side 800b of the substrate 800. These metal patches 111, 113 are placed below a waveguide feeding terminal 103 and a single waveguide transition terminal 101 of a stripline 121 placed on the top side 800a of the substrate 800 as shown in FIG. 8B.

The metal patches 111, 113 are configured to shape a coupling of the electrical signal with the radio frequency signal in order to match the stripline 121 to the waveguide.

The metal patches 111 113 may be rectangular shaped as shown in FIG. 8A. The metal patches 111, 113 may be made of Copper, for example.

The substrate 800 may be a printed circuit board (PCB) comprising a top side metallization and a bottom side metallization. The stripline 121 as shown in FIG. 8B may be formed as an etched signal trace within the top side metallization. The metal patches 111, 113 may be formed as etched metal islands within the bottom side metallization.

FIG. 8B shows a schematic diagram illustrating the top side 800a of the substrate 800 of the apparatus.

As described above, the substrate 800 is a dielectric substrate 800 having a top side 800a and a bottom side 800b opposing the top side 800a. In FIG. 8B, the top side 800a of the substrate 800 is shown. A stripline 121 is placed at the top side 800a of the substrate 800. The stripline 121 comprises a waveguide feeding terminal 103 for feeding the apparatus 200 with an electrical signal and a waveguide transition terminal 101 for transition of the electrical signal into a radio frequency signal via a waveguide. The waveguide may be similar to one half of the waveguide 210 shown in FIG. 2.

The metal patches 111, 113 shown in FIG. 8A are placed at the bottom side 800b of the substrate 800 below the waveguide feeding terminal 103 and the waveguide transition terminal 101.

The metal patches 111, 113 are configured to shape a coupling of the electrical signal with the radio frequency signal in order to match the stripline 121 to the waveguide.

The waveguide can be attached to the substrate 800. The waveguide may be a stepless waveguide having a constant cross-section.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless of whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not intended to be limited to being implemented in that particular sequence.

Many alternatives, modifications, and variations will be apparent to those skilled in the art in light of the above teachings. Of course, those skilled in the art readily recognize that there are numerous applications of the present disclosure beyond those described herein. While the present disclosure has been described with reference to one or more particular forms, those skilled in the art recognize that many changes may be made thereto without departing from the scope of the present disclosure. It is therefore to be understood that within the scope of the appended claims and their equivalents, the present disclosure may be practiced otherwise than as specifically described herein.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. An apparatus for transition between an electrical signal and a radio frequency signal, the apparatus comprising:
a dielectric substrate having a top side and a bottom side opposing the top side;
a stripline placed at the top side of the dielectric substrate, the stripline comprising:
a waveguide feeding terminal configured to feed the apparatus with an electrical signal; and
at least one waveguide transition terminal configured to transition the electrical signal into a radio frequency signal via a waveguide; and
at least one metal patch placed at the bottom side of the dielectric substrate below at least one of the waveguide feeding terminal and the at least one waveguide transition terminal,
wherein the at least one metal patch is configured to shape a coupling of the electrical signal with the radio frequency signal in order to match the stripline to the waveguide.

2. The apparatus of claim 1, further comprising the waveguide attached to the dielectric substrate, wherein the waveguide is a stepless waveguide having a constant cross-section.

3. The apparatus of claim 1,
wherein the waveguide feeding terminal and the at least one waveguide transition terminal are each formed as inductive fingers; and
wherein the at least one metal patch is a capacitive component that interacts with the inductive fingers of the waveguide feeding terminal and the at least one wavequide transition terminal and is configured to form an impedance of the waveguide feeding terminal and the at least one waveguide transition terminal.

4. The apparatus of claim 3, wherein the at least one waveguide transition terminal includes at least two waveguide transition terminals, each of the at least two wavequide transition terminals are formed as inductive fingers, and the inductive fingers of the at least two waveguide transition terminals are aligned to point in a same direction.

5. The apparatus of claim 1, wherein the at least one metal patch is rectangular shaped.

6. The apparatus of claim 1, wherein the stripline comprises a suspended-stripline.

7. The apparatus of claim 6, wherein the waveguide comprises a double-ridge waveguide.

8. The apparatus of claim 1, wherein the waveguide comprises a double-ridge waveguide.

9. The apparatus of claim 1,
wherein the dielectric substrate is a printed circuit board comprising a top side metallization and a bottom side metallization; and
wherein the stripline is formed as an etched signal trace within the top side metallization and the at least one metal patch is formed as an etched metal island within the bottom side metallization.

10. The apparatus of claim 9, further comprising:
an upper ground plane arranged above the top side of the dielectric substrate outside an outline of the etched signal trace;
a lower ground plane arranged below the bottom side of the dielectric substrate outside an outline of the etched metal island; and
a series of vias electrically connecting the upper ground plane with the lower ground plane.

11. The apparatus of claim 1, wherein the at least one waveguide transition terminal comprises two waveguide transition terminals to form a 1-to-2 combiner-divider device.

12. The apparatus of claim 1, wherein the at least one waveguide transition terminal comprises four waveguide transition terminals to form a 1-to-4 combiner-divider device.

13. The apparatus of claim 1, wherein the at least one waveguide transition terminal comprises a single waveguide transition terminal to form a 1-to-1 coupling device.

14. The apparatus of claim 1, wherein the stripline comprises stepped sections, and the stepped sections are configured to shape an impedance of the waveguide feeding terminal and the at least one waveguide transition terminal.
